(19) United States
(12) Patent Application Publication
(10) Pub. No.: US 2021/0354088 A1
(43) Pub. Date: Nov. 18, 2021

(54) METHOD FOR THE PRODUCTION OF DRINKING WATER

(71) Applicant: UNIVERSITEIT TWENTE, ENSCHEDE (NL)

(72) Inventors: Timon Rijnaarts, ENSCHEDE (NL); Wiebe Matthijs De Vos, ENSCHEDE (NL); Walterus Gijsbertus Joseph Van Der Meer, ENSCHEDE (NL)

(21) Appl. No.: 17/280,739

(22) PCT Filed: Sep. 24, 2019
(86) PCT No.: PCT/NL2019/050643

§ 371 Date: Mar. 26, 2021

(30) Foreign Application Priority Data
Sep. 28, 2018 (NL) 2021733

(51) Int. Cl. B01D 61/58; B01D 61/02; B01D 61/04; B01D 61/24; B01D 61/44; C02F 1/44; C02F 1/469

(52) U.S. Cl. CPC B01D 61/58; B01D 61/025; B01D 61/027; B01D 61/04; B01D 61/243; B01D 61/44; C02F 2103/06; C02F 1/442; C02F 1/4693; B01D 2311/06; B01D 2311/08; B01D 2311/25; C02F 1/441

(57) ABSTRACT

The present invention relates to a method for the production of drinking water. In addition, the present invention also relates to the use of minerals extracted from a feed water stream by using a combination of a Donnan dialysis unit and a membrane unit as a source of minerals for the production of drinking water originating from said feed water stream.

The present invention relates to a method for the production of drinking water.

Drinking water supplies in the Netherlands are among the safest in the world. However drinking water sources can become contaminated, causing sickness and disease from waterborne germs, such as Cryptosporidium, E. coli, Hepatitis A, Giardia intestinalis, and other pathogens.

A drinking water company provides people and companies with reliable and fresh drinking water every day. For example, anaerobic groundwater, which originates from the river as river bank filtrate, is purified to drinking water of impeccable quality. The water treatment plants may need higher standards with regards to the removal of organic micro pollutants, such as traces of medicines, pesticides and industrial byproducts. Another challenge is the possible increase in salinity, due to intensified fresh water use and climate change. Such a treatment concept may be the use of dense reverse osmosis (RO) membranes, which provide an excellent barrier for chloride and organic micro pollutants. The product water of RO, called permeate, requires post-treatment to improve salinity index (SI) and taste and to comply with the legal standards for drinking water under Dutch law. In this so-called remineralization step, calcium, magnesium and bicarbonate are added to the water. As a final step, CO₂ and methane are stripped, while oxygen is added. The water produced has an ultra-low growth potential, providing a natural limitation on bacterial growth during distribution to customers.

A lot of research has been conducted into the optimal remineralization technology. It was hypothesized that possibly new contaminants, such as traces of heavy metals, are introduced into the water by remineralization. Another concern is the introduction of nutrients by the natural minerals used, potentially resulting in exponential growth of bacteria, since no natural equilibrium is present in permeate. Closely related to remineralization is the potential precipitation of calcium carbonate. The presence of particles in the water may in specific cases result in serious scaling when temperature increases. The remineralization step should be operated in such a way that the risk on scaling is kept to a minimum. For the addition of magnesium, possible sources and technologies ion exchange, (half-burnt and micronized) dolomite, magnesium sulphate and magnesium chloride can be considered. Different technologies for the addition of calcium carbonate can be mentioned, such as granular calcite filtration, also known as marble filter or calcite contactor, micronized calcite (Membrane Calcite Reactor (MCR)), and calcium chloride as a dosing option, either with sodium hydroxide (NaOH) and CO2 (a) or sodium bicarbonate (Na₂HCO₃) as the bicarbonate source (b).

On basis of the above discussion drinking water sources are subject to contamination and require appropriate treatment to remove disease-causing agents. Public drinking water systems use various methods of water treatment to provide safe drinking water for their communities. Today, the most common steps in water treatment used by community water systems (mainly surface water treatment) include several steps, such as coagulation, flocculation, sedimentation, filtration and sedimentation. Coagulation and flocculation are often the first steps in water treatment. Chemicals with a positive charge are added to the water. The positive charge of these chemicals neutralizes the negative charge of dirt and other dissolved particles in the water. When this occurs, the particles bind with the chemicals and form larger particles, called floc. During sedimentation, floc settles to the bottom of the water supply, due to its weight. This settling process is called sedimentation. Once the floc has settled to the bottom of the water supply, the clear water on top will pass through filters of varying compositions (sand, gravel, and charcoal) and pore sizes, in order to remove dissolved particles, such as dust, parasites, bacteria, viruses, and chemicals. After the water has been filtered, a disinfectant (for example, chlorine, and chloramine) may be added in order to kill any remaining parasites, bacteria, and viruses, and to protect the water from germs when it is piped to homes and businesses.

On basis of the above one can say there is an issue with the current water safety. Micro pollutants, carcinogenic chemicals and hormone levels are increasing in the surface and groundwater that is used to produce drinking water. To overcome this, Nanofiltration (NF) and specifically Reverse Osmosis (RO) membrane technology has been suggested to produce drinking water without any of these chemical contaminants. However, in such a production method approximately 20% of the water is wasted and minerals have to be added separately.

In the last few decades, the amount of drinking water produced with reverse osmosis technology increased enormously. Moreover, high water quality standards have been adopted, which promoted the development of novel post-treatment processes. Remineralisation of RO permeate is a post-treatment process required to protect public health and safeguard the integrity of the water distribution system. Currently, remineralization is done by either passing the RO permeate over a calcite (calcium carbonate) bed, introducing lime (calcium hydroxide) in the treated water stream together with carbon dioxide or blending with another water resource.

Reverse osmosis (RO) is a suitable membrane filtration technique that allows the production of clean water with high retentions for salts and most of the micropollutants. If the feed water source has a low concentration of monovalent salts and micropollutants with a higher molecular weight of 200-300 Da, energy-efficient Nanofiltration (NF) can be also used. However, the produced water with NF and RO requires the remineralization to 1 mM of hardness for the Dutch drinking water regulations. This prevents dissolution of drinking water pipes made of copper typically. Typically, CaHCO₃ salts are mined in Belgium and are added to this pure water. In addition to this remineralization, a part of the groundwater cannot be used due to high concentrations of these pollutants. This waste stream depends to a large extent on the hardness of the groundwater, as with a high concentration of hardness in the feed water scaling (mineral deposits) on the membrane and spacers can occur. Typically 20% of the water is wasted and this water (the retentate) contains 5 times the initial hardness.

Thus, NF and RO membranes and devices are being used widely in the water purification industry. NF and RO devices work on the principle of reduction in dissolved solids from the input water. Water has a particular taste partly because of the dissolved solids. Removal of dissolved solids beyond a certain point may adversely affect the taste. Similarly, if higher amount of dissolved solids remain in the output water (also called permeate), the taste of water may still be unpalatable at least to some consumers. Therefore, in order to adjust the taste of permeate water, remineralization means are used in some NF and RO devices.

In that context EP 2 753 581 relates to a device for purification of water comprising: a reverse-osmosis membrane; and, downstream thereof, a cartridge comprising calcium carbonate and magnesium carbonate, wherein the ratio of calcium carbonate to magnesium carbonate is from 95:5 to 60:40. This EP 2 753 581 also discloses a process for purifying water, said process comprising the steps of: passing water comprising total dissolved solids of 100 to 2000 ppm through a reverse-osmosis membrane; followed by, passing said water through a cartridge comprising calcium carbonate and magnesium carbonate.

US 2002/0158018 relates to a process for producing improved alkaline drinking water, which comprises the steps of: filtering potable water from a source thereof so as to remove particles greater than a preselected size; directing the filtered source water through a water purification unit so as to produce purified water with a total dissolved solids no greater than ten ppm; adding selected alkaline minerals to the purified water so that the resulting mineralized water has a selected mineral concentration; and electrolyzing the mineralized water to produce alkaline water with a pH in the range 9-10.

WO 2009/135113 relates to a water treatment system for remineralization of purified water comprising: a reverse osmosis filter; a manifold for delivering water to be treated to said reverse osmosis filter: a replaceable cartridge containing a granular or solid magnesium compound: a storage tank to accumulate at least partially treated water; a dispenser for dispensing treated water from said treatment system; a second filter that is in fluid communication with said storage tank and having an outlet in fluid communication with a said dispenser.

WO 2010/012691 relates to a process for treating water that contains at least calcium and/or magnesium salts through membranes of reverse osmosis type, said process comprising at least one step of recovering water that is at least partly desalinated, a step of recovering a concentrate originating from said membranes and that contains bicarbonates, a step of injecting CO₂ or an acid into said at least partly desalinated water, and a step of remineralization of said at least partly desalinated water within a remineralization reactor, wherein the process comprises a step of decarbonation of said concentrate so as to form carbonates, and a step of recycling at least one portion of said carbonates within said remineralization reactor.

U.S. Pat. No. 7,771,599 relates to the remineralization of process water without the need for an external supply of carbon dioxide, especially to a method for remineralizing in a desalination system preferring reverse osmosis (RO) permeate. In accordance with that method, carbon dioxide gas (CO₂) is sequestered from seawater or the concentrate of desalination processes via a gas transfer membrane. The carbon dioxide gas (CO₂) is thereafter used in the production of soluble calcium bicarbonate (Ca(HCO₃)₂). The calcium bicarbonate (Ca(HCO₃)₂) adds hardness and alkalinity to the desalinated water so as to yield potable water.

In an article written by Van Oppen, Marjolein et al “Increasing RO efficiency by chemical-free ion-exchange and Donnan dialysis: Principles and practical implications’, WATER RESEARCH, 80, (2015-05-08), 59-70, two different reverse osmosis (RO) feed streams (treated industrial waste water and simple tap water) were tested in ion-exchange (IEX)—RO and Donnan dialysis—RO including RO concentrate recycling. According to the article the efficiency of multivalent cation removal depends mainly on the ratio of monovalent to multivalent cations in the feed stream, influencing the ion-exchange efficiency in both IEX and DD. The article mentions that recycling of RO concentrate to regenerate ion exchange pre-treatment techniques for RO is an option to increase RO recovery without addition of chemicals, but only at high monovalent/multivalent cation-ratios in the feed stream.

US 2017/152154 relates to a reverse osmosis system comprising a feed water inlet, a reverse osmosis module coupled to the feed water inlet, the reverse osmosis module producing permeate water, providing water to a permeate outlet, and including a reverse osmosis membrane, wherein a reverse osmosis membrane in the reverse osmosis module includes membrane spacers configured to compensate a decreasing volumetric flow rate of the feed water. The reverse osmosis system further comprises a bypass port upstream of the reverse osmosis module in fluid communication with a blend port downstream of the reverse osmosis module, the bypass port configured to provide feed water to the blend port, the blend port configured to combine feed water with permeate water to produce mixed water.

The present inventors noticed that a disadvantage of a drinking water production process using Reverse Osmosis (RO) membranes is that 20% of the water is wasted to flush away minerals and chemical contaminants. Moreover, minerals (such as Ca²⁺ and Mg²⁺) need to be added to this water to a concentration of at least 1 mM (accordance to legislation requirements). These minerals need to be bought, for example from foreign countries, which requires additional transportation, cleaning and costs.

An object of the present invention is to provide a method for the production of drinking water wherein minerals originally present in the feed water are re-used in the production of drinking water.

Another object of the present invention is to provide a method for the sterile production of drinking water.

An object of the present invention is to provide a method for the production of drinking water wherein minerals that cause scaling on membranes are removed.

An object of the present invention is to provide a method for the production of drinking water wherein mineral deposition on membranes is reduced to a minimum.

The present invention as mentioned above relates to a method for the production of drinking water, wherein the present method comprises the following steps:

i) providing a feed water stream;

ii) treating said feed water stream of i) in a Donnan dialysis unit thereby producing a feed water stream depleted from divalent cations and an effluent stream enriched with divalent cations;

iii) treating said feed water stream depleted from divalent cations of i) in a membrane unit thereby producing a concentrate stream and a permeate stream:

iv) combining said permeate stream of iii) with said effluent stream enriched with divalent cations of ii) for the production of drinking water.

On basis of the above method one or more objects have been achieved. The present invention thus solves the 20% water waste by removing minerals that prevent optimal functioning of the Reverse Osmosis water purification. In this way, only 5%-15% water is wasted to wash out salts and contaminants. It also allows minerals from the groundwater source to be added to the pure water, for drinking water quality. The minerals are extracted in a Donnan Dialysis (DD). The present inventors found that the waste water stream can be decreased from 20% down to 5% (similar to conventional drinking water production processes). In addition, the present inventors also found that the minerals for the required drinking water hardness can be exchanged from the groundwater using membranes as barriers (so without introducing contaminants in the drinking water). Both aspects come from the use of Donnan Dialysis (DD) as pretreatment for the membrane process. DD can exchange the divalent cations in the feed water with monovalent ions. As the divalent cations are removed before the membrane process, scaling occurs at higher recoveries and hence less water is wasted. The divalent cations that are exchange by the DD, can be reused to remineralize the drinking water. For example, the mono- (sodium) and divalent (calcium, magnesium) cations can be separated using another membrane unit, such as nanofiltration (NF). The divalent cation enriched NF-retentate can be added to the pure RO permeate for remineralization, while the divalent cation lean NF-permeate can be reused as draw solution in the DD.

According to an embodiment of step iv) of the present invention a part of the effluent stream enriched with divalent cations of step ii) is combined with the permeate stream of step iii) to obtain a desired amount of divalent cations in the resulting drinking water.

According to another embodiment of step iv) of the present invention the complete effluent stream enriched with divalent cations of step ii) is combined with the permeate stream of step iii) to obtain a desired amount of divalent cations in the resulting drinking water.

According to an embodiment of the present invention the Donnan Dialysis unit is operated in such a way that a feed water stream partly depleted from divalent cations is produced. Such a feed water stream partly depleted from divalent cations is subsequently treated in a membrane unit thereby producing a concentrate stream and a permeate stream. Donnan dialysis utilizes counter diffusion of two or more ions through an ion exchange membrane to achieve an exchange. In a Donnan Dialysis unit a feed solution, containing the ions (for example Ca²⁺) that should be removed is fed on one side of the ion exchange membrane, while a “concentrate” solution, containing another electrolyte (for example Na⁺) at a relatively higher concentration compared to the feed solution, is fed on the other side. Because of the concentration difference between the two solutions, there is a net driving force for calcium transport from the feed to the concentrate and for sodium from the concentrate to the feed. Since the anions present can't move across the cation exchange membrane, for every calcium molecule, two sodium molecules move from the concentrate to the feed to maintain electro neutrality. However, when the calcium concentration on both sides of the membrane is equal, transport will still carry on, due to the higher electrochemical potential of sodium compared to calcium, causing calcium to transport against its concentration gradient to allow sodium transport. Transport of divalent cations across the membrane continues until the electrochemical potential difference of all ions across the membrane are equal. This potential difference scales to the power 1/ionic charge, and thus means that divalent ions generate less potential at the some concentration. This leads to a lower final concentration of divalent ions in the solution. At this point, Donnan equilibrium across the membrane is reached and the solutions are in equilibrium. No more transport will thus occur. The principle of Donnan Dialysis has been disclosed in U.S. Pat. No. 3,454,490, the contents thereof are here considered to be incorporated. For the present Donnan Dialysis an ion exchange membrane, more specifically a cation exchange membrane, is used. Examples thereof are, but not exclusively, a Neosepta CMX/CSE, Selemion CMV, Fumatech FKS, PCA PC-SK or FUJIFILM Type 10 cation exchange membrane. For these cation exchange membranes a high permselectivity (>95%) is preferred.

A benefit of the present invention is that the reverse osmosis process is improved by removing minerals that cause scaling and mineral deposition on the RO membranes. This allows it to run at higher efficiencies and waste only 5%-15% water.

It has to be noted that the present methods allows sterile extraction of minerals due to the use of a barrier (a dense membrane). Other methods for removing hardness from water sources, such as ion exchange, cannot be operated sterile, hence such a method is not directly safe to use on drinking water. The operation can be sterile but requires other cleaning steps.

In an embodiment of step ii) of the method for the production of drinking water the effluent stream enriched with divalent cations is treated in a nano filtration unit (NF) for recovering said divalent cations, said nano filtration unit (NF) producing a concentrate stream enriched with divalent cations and a permeate, said concentrate stream enriched with divalent cations being used in step iv) as said effluent stream enriched with divalent cations, said permeate being used as a draw solution in said Donnan dialysis unit. In another embodiment of this step ii) only a part of the effluent stream enriched with divalent cations is treated in a nano filtration unit (NF) for recovering the divalent cations.

A benefit of the present invention is that the Donnan Dialysis (DD) process in combination with nanofiltration (NF) allows to extract minerals from the groundwater and separate these minerals to add them again in the final drinking water. In this way, one can mineralize the pure water from the RO to drinking water by using minerals already present in the groundwater.

In an embodiment of step ii) of the method for the production of drinking water the effluent stream enriched with divalent cations is treated in a selective electrodialysis unit (S-ED) for recovering said divalent cations by selectively removing only the monovalent cations using monovalent-selective cation exchange membranes, said selective electrodialysis unit (S-ED) producing a stream enriched with divalent cations and an S-ED effluent stream rich in monovalent salts, said stream enriched with divalent cations being used in step iv) as said effluent stream enriched with divalent cations, said S-ED effluent stream rich in mono valent salts being used as draw solution in said Donnan dialysis unit. In another embodiment of this step ii) only a part of the effluent stream enriched with divalent cations is treated in a selective electrodialysis unit (S-ED) for recovering the divalent cations.

In an embodiment of step ii) of the method for the production of drinking water the effluent stream enriched with divalent cations is first treated in a nano filtration unit (NF) for recovering said divalent cations, said nano filtration unit (NF) producing a concentrate stream enriched with divalent cations and a permeate, said permeate being used as a draw solution in said Donnan dialysis unit, wherein said concentrate stream enriched with divalent cations is further treated in a selective electrodialysis unit (S-ED) for recovering said divalent cations by selectively removing monovalent cations using monovalent selective cation exchange membranes, said selective electrodialysis unit (S-ED) producing a stream enriched with divalent cations and an S-ED effluent stream, said stream enriched with divalent cations being used in step iv) as said effluent stream enriched with divalent cations, said S-ED effluent stream rich in monovalent salts being used as a draw solution in said Donnan dialysis unit. In another embodiment of this step ii) only a part of the effluent stream enriched with divalent cations is treated in a nano filtration unit (NF) for recovering the divalent cations. In another embodiment of this step ii) only a part of the concentrate stream enriched with divalent cations is further treated in a selective electrodialysis unit (S-ED) for recovering the divalent cations.

In an embodiment of the method for the production of drinking water a draw solution in said Donnan dialysis unit comprises a solution of monovalent cations chosen from the group of sodium and potassium salts, or a combination thereof, preferably a sodium chloride solution. Examples of such a draw solution include NaCl, KCl, NaHCO₃ and KHCO₃.

In an embodiment of the method for the production of drinking water the membrane unit in iii) is chosen from the group of nanofiltration (NF) unit and reverse osmosis (RO) unit, especially wherein said membrane unit in iii) is a reverse osmosis (RO) unit. Pressure-driven membrane processes nanofiltration (NF) and reverse osmosis (RO) are considered as treatments that seem to be able to effectively remove most organic and inorganic compounds and microorganisms from raw water.

In an embodiment of the method for the production of drinking water the concentration of divalent cations in the drinking water produced in iv) is in a range between 1.0 and 2.5 mM.

In an embodiment of the method for the production of drinking water the maximum concentration of monovalent cations in the drinking water produced in iv) is 150 mg/L.

The present invention also relates to the use of minerals extracted from a feed water stream by using a combination of a Donnan dialysis unit and a membrane unit as a source of minerals for the production of drinking water originating from said feed water stream. This means that no foreign minerals need to be added to the drinking water for remineralization purposes.

In some types of feed water ammonium is present. The cation ammonium is undesired in the final drinking water. The present inventors found that in Donnan dialysis ammonium is also exchanged. As a result, ammonium is being removed from the feed water and shows up in the draw solution as well. In some experiments ammonium exchanges comparably with the divalent cations up to approximately 50% of all divalent cations. In order to decrease the ammonium exchange, which is governed by the concentration gradient in the Donnan dialysis unit, one may increase the NF recovery (as NF hardly has any retention for NH₄) and/or decrease the draw volume in the Donnan dialysis unit so the NH₄ equilibrium is reached at a lower amount of ions transported. Such an action may decrease the ammonium more, down to 5% exchange which leads to an acceptable low amount, for example <0.008 mM NH₄, in the final drinking water with remineralization. According to another embodiment the ammonium in the remineralization stream may be decreased by using multiple stages of Donnan dialysis, i.e. several Donnan dialysis units placed in series. According to another embodiment the ammonium in the remineralization stream may be decreased by diluting the NF concentrate with some RO permeate (diafiltration mode) to decrease the ammonium concentration in the NF concentrate further.

For better understanding of the invention, reference should be made to the detailed description of preferred embodiments and process schemes.

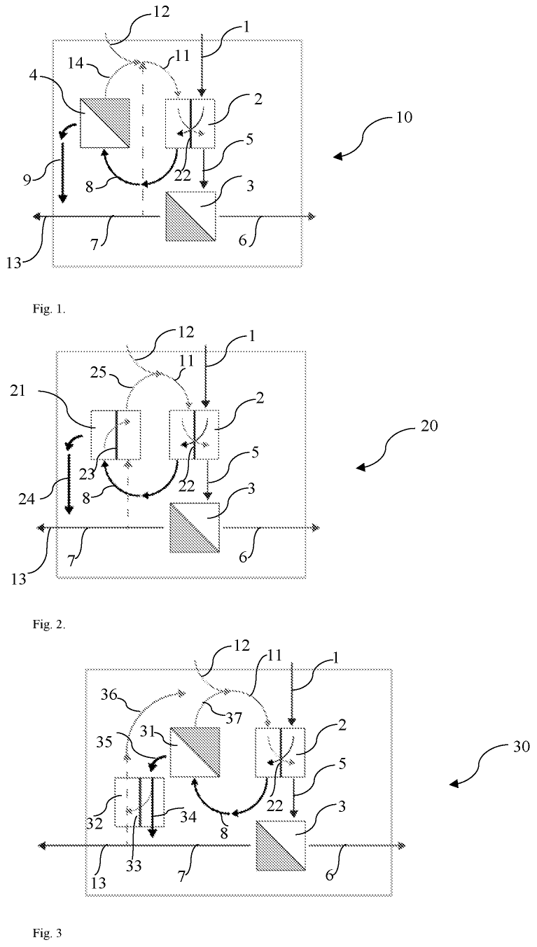

FIG. 1 shows an embodiment according to the present invention.

FIG. 2 shows another embodiment according to the present invention.

FIG. 3 shows another embodiment according to the present invention.

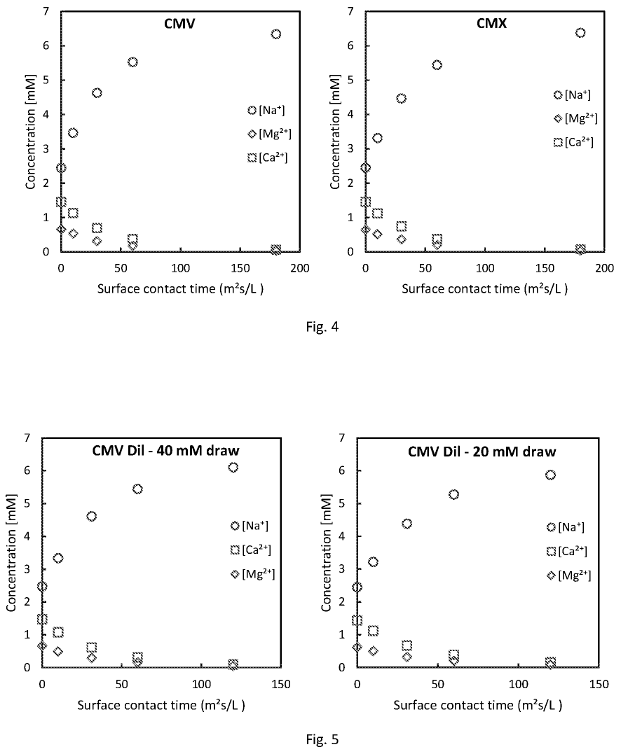

FIG. 4 shows the results of a Donnan dialysis hardness removal of groundwater.

FIG. 5 shows the Donnan dialysis hardness removal of groundwater.

FIG. 1 shows a process where Donnan Dialysis (DD) is used to exchange divalent cations from feed water with monovalent cations. Nanofiltration (NF) is used to separate mono and divalent cations from the DD draw solution. The NF retentate is used for drinking water remineralization (combined with RO permeate). The NF permeate is reused as DD draw solution with additional monovalent salt.

According to the process scheme 10 shown in FIG. 1 a feed water stream 1 containing dissolved cations, such as calcium and magnesium, is treated in a Donnan dialysis unit 2 comprising a membrane 22. In the Donnan dialysis unit 2 a draw solution 11 is present as well. Due to the driving force the divalent cations, such as magnesium ions and calcium ions, are transferred to the draw solution 11 resulting in a feed water stream 5 depleted from divalent cations. The feed water stream 5 depleted from divalent cations is subsequently sent to a membrane unit 3, for example of the type reverse osmosis. The membrane unit 3 produces a concentrate stream 6 and a permeate stream 7. The concentrate stream 6 can be identified as a waste stream. The effluent 7 from the membrane unit is a permeate stream. The effluent stream 8 enriched with divalent cations from the Donnan dialysis unit 2 is further treated in another membrane unit 4, for example a nano filtration unit. The concentrate stream 9 produced in the nano filtration unit 2 now contains the cations originally present in the feed water stream 1 and is subsequently mixed with the permeate stream 7 from the reverse osmosis thereby producing drinking water 13. The permeate stream 14 produced in the nano filtration unit 4 is supplied as draw solution 11 to the Donnan dialysis unit 2. In the beginning of the process a solution 12 containing monovalent salts, preferably Na⁺ or K⁺ salts, is used as a draw solution.

FIG. 2 shows a process where Donnan Dialysis (DD) is used to exchange divalent cations from feed water with monovalent cations. Selective ED (S-ED) is used to separate mono and divalent cations from the DD draw solution. The S-ED is using monovalent selective cation exchange membranes to remove the monovalent salts from the stream containing the Ca/Mg. The Ca/Mg-containing stream can be reused for drinking water remineralization. The monovalent salts are reused for DD draw solution with additional monovalent salt.

According to the process scheme 20 shown in FIG. 2 a feed water 1 stream containing dissolved cations, such as calcium and magnesium, is treated in a Donnan dialysis unit 2 comprising a membrane 22. In the Donnan dialysis unit 2 a draw solution 11 is present as well. Due to the driving force the divalent cations, such as magnesium ions and calcium ions, are transferred to the draw solution resulting in a feed water stream 5 depleted from divalent cations. The feed water stream 5 depleted from divalent cations is subsequently sent to a membrane unit 3, for example of the type reverse osmosis. The membrane unit 3 produces a concentrate stream 6 and a permeate stream 7. The concentrate stream 6 can be identified as a waste stream. The effluent 7 from the membrane unit 3 is a permeate stream. The effluent stream 8 enriched with divalent cations from the Donnan dialysis unit 2 is further treated in a selective electrodialysis unit 21 (S-ED). In selective electrodialysis unit 21 (S-ED) a membrane 23 is present. A concentrate stream 24 produced in the S-ED 21 now contains the cations originally present in the feed water stream 1 and is subsequently mixed with the permeate stream 7 from the reverse osmosis 3 thereby producing drinking water 13. The retentate stream 25 produced in the S-ED 21 is supplied as draw solution to the Donnan dialysis unit. In the beginning of the process a solution 12 containing monovalent salts, preferably Na⁺ or K⁺ salts, is used as a draw solution.

FIG. 3 shows a process 30 where Donnan Dialysis (DD) is used to exchange divalent cations from feed water with monovalent cations. Nanofiltration (NF) is used to separate mono and divalent cations from the DD draw solution. The NF retentate is further treated by selective ED (S-ED) to remove monovalent ions, to meet the required quality of drinking water. The water with divalent cations is then used for drinking water remineralization (combined with RO permeate). The NF permeate is reused as DD draw solution with additional monovalent salt.

The process scheme 30 shown in FIG. 3 can be seen as a kind of a combination of the process scheme shown in both FIGS. 2 and 3. According to the process scheme shown in FIG. 3 a feed water stream 1 containing dissolved cations, such as calcium and magnesium, is treated in a Donnan dialysis unit 2 comprising a membrane 22. In the Donnan dialysis unit 2 a draw solution is present as well. Due to the driving force the divalent cations, such as magnesium ions and calcium ions, are transferred to the draw solution resulting in a feed water stream 5 depleted from divalent cations. The feed water stream 5 depleted from divalent cations is subsequently sent to a membrane unit 3, for example of the type reverse osmosis. The membrane unit 3 produces a concentrate stream 6 and a permeate stream 7. The concentrate stream 6 can be identified as a waste stream. The effluent 7 from the membrane unit 3 is a permeate stream. The effluent stream 8 enriched with divalent cations from the Donnan dialysis unit 2 is further treated in a nano filtration unit 31. The concentrate stream 35 produced in the nano filtration unit 31 now contains the cations originally present in the feed water stream 1 and is subsequently treated in a selective electrodialysis unit 32 (S-ED) to remove excess of monovalent salts. In selective electrodialysis unit 32 (S-ED) a membrane 33 is present. A concentrate stream 34 produced in the S-ED 32 now contains the cations originally present in the feed water stream 1 and is subsequently mixed with the permeate stream 7 from the reverse osmosis 3 thereby producing drinking water 13. The monovalent-salt enriched stream 36 produced in the S-ED 32 is supplied as a draw solution to the Donnan dialysis unit 2. The permeate stream 37 produced in the nano filtration unit 31 is supplied as a draw solution to the Donnan dialysis unit, too. In the beginning of the process a solution 12 containing monovalent salts, preferably Na⁺ or K⁺ salts, is used as a draw solution.

### EXAMPLES

For a first set of tests, small diffusion cells were used. Hardness removal from groundwater over time with 0.1 M NaCl draw solution with two different membranes can be seen in FIG. 4. FIG. 4 shows a graph of feed water treated by in DD with 100 mM NaCl solution using CMV and CMX membranes over time, using lab-scale DD units, i.e. the results of a Donnan dialysis hardness removal of groundwater with 100 mM NaCl draw solution and two types of membranes, namely CMV or CMX membranes. The cations Mg²⁺ and Ca²⁺ are exchanged with (twice as much moles of) Na⁺ for a certain period of time. After approximately 60 m² s/L (surface contact time) about 75% of the hardness is removed. This is sufficient for the reverse osmosis to run on a higher recovery (from 80 to 90 or 95%).

The present inventors did test with less NaCl for the draw solution. This may result in a lower NaCl concentration in the final drinking water, i.e. not to exceed 150 mg/L (or 4 mM). The inventors also tested with 40 and 20 mM NaCl draw solutions for Donnan Dialysis, as shown in FIG. 5. FIG. 5 shows a graph of feed water treated by in DD with 40 and 20 mM NaCl solution using CMV membranes over time, using lab-scale DD units, i.e. the Donnan dialysis hardness removal of groundwater with 40 and 20 mM NaCl draw solution with a CMV membrane. From FIG. 5 one can see that almost the same hardness removal has been achieved here. This means there is still sufficient driving force for ion exchange. In fact, with a relatively low concentration of approximately brackish water (20 mM NaCl), the inventors are able to soften groundwater. This is promising to be able to recover hardness from the draw solution and then to make the draw solution suitable for adding to the RO permeate with a single NF step.

On basis of the above the present inventors conclude that Donnan dialysis is easily scalable for hardness removal. Moreover, membranes with sufficiently high permselectivity (>95%) are able to perform the exchange without too much salt leakage. For remineralization a draw solution having a slightly higher salt concentration as the feed water will ensure sufficient driving force. For example, in an embodiment 20 mM of sodium is enough to exchange ˜30% of divalent cations for remineralization purposes. The salt can be in any anion form, i.e. chloride, bicarbonate, hydroxide or even sulfate. The present inventors found that ammonium in the feed water transports as well through the membranes of a Donnan dialysis unit. In that context, a staged Donnan dialysis unit may be used, where the first stage Donnan dialysis unit is used to remove ammonium to a large extent, and in the second stage Donnan dialysis unit hardness is recovered for the mineralization step.

For the recovery of the minerals using nanofiltration, open nanofiltration (NF) membranes can be used that have low (0˜5%) retention for monovalent cations (i.e. sodium and ammonium) and moderate (20-30%) retention for divalent cations (i.e. calcium and magnesium) with groundwater concentrations. In this embodiment dNF80 membranes manufactured by NX Filtration BV (NL) were used. Approximate membranes fluxes for this separation are between 25 to 50 liters of permeate per m² membrane area per hour (LMH) at 6 bar transmembrane pressure.

1. A method for production of drinking water, wherein the method comprises the following steps:
i) providing a feed water stream;
ii) treating said feed water stream of i) in a Donnan dialysis unit thereby producing a feed water stream depleted from divalent cations and an effluent stream enriched with divalent cations;
iii) treating said feed water stream depleted from divalent cations of i) in a membrane unit thereby producing a concentrate stream and a permeate stream; and
iv) combining said permeate stream of iii) with said effluent stream enriched with divalent cations of ii) for the production of drinking water.

2. The method for the production of drinking water according to claim 1, wherein in ii) said effluent stream enriched with divalent cations is treated in a nano filtration unit (NF) for recovering said divalent cations, said nano filtration unit (NF) producing a concentrate stream enriched with divalent cations and a permeate, said concentrate stream enriched with divalent cations being used in step iv) as said effluent stream enriched with divalent cations, said permeate being used as a draw solution in said Donnan dialysis unit.

3. The method for the production of drinking water according to claim 1, wherein in ii) said effluent stream enriched with divalent cations is treated in a selective electrodialysis unit (S-ED) for recovering said divalent cations by removing monovalent cations, said selective electrodialysis unit (S-ED) producing a stream enriched with divalent cations and an S-ED effluent stream enriched with monovalent cations, said stream enriched with divalent cations being used in step iv) as said effluent stream enriched with divalent cations, said S-ED effluent stream being used as draw solution in said Donnan dialysis unit.

4. The method for the production of drinking water according to claim 1, wherein in ii) said effluent stream enriched with divalent cations is first treated in a nano filtration unit (NF) for recovering said divalent cations, said nano filtration unit (NF) producing a concentrate stream enriched with divalent cations and a retentate, said retentate being used as a draw solution in said Donnan dialysis unit, wherein said concentrate stream enriched with divalent cations is further treated in a selective electrodialysis unit (S-ED) for recovering said divalent cations, said selective electrodialysis unit (S-ED) producing a stream enriched with divalent cations and an S-ED effluent stream, said stream enriched with divalent cations being used in step iv) as said effluent stream enriched with divalent cations, said S-ED effluent stream being used as a draw solution in said Donnan dialysis unit.

5. The method for the production of drinking water according to claim 1, wherein a draw solution in said Donnan dialysis unit comprises a solution of monovalent cations having at least one of sodium salts, potassium salts, or a combination thereof.

6. The method for the production of drinking water according to claim 5, wherein said draw solution is a sodium chloride solution.

7. The method for the production of drinking water according to claim 1, wherein said membrane unit in iii) is at one of of a nanofiltration (NF) unit and or a reverse osmosis (RO) unit.

8. The method for the production of drinking water according to claim 1, wherein a concentration of divalent cations in the drinking water produced in iv) is in a range between 1.0 and 2.5 mM.

9. The method for the production of drinking water according to claim 1, wherein the maximum concentration of monovalent cations in the drinking water produced in iv) is 150 mg/L.

10. The method for the production of drinking water according to claim 1, wherein in step iv) said effluent stream enriched with divalent cations of step ii) is combined with said permeate stream of step iii) to obtain a desired amount of divalent cations in the drinking water.

11. The method for the production of drinking water according to claim 1, wherein in step ii) said Donnan dialysis unit comprises multiple stages of Donnan dialysis, namely several Donnan dialysis units placed in series.

12. The method for the production of drinking water according to claim 11, wherein said Donnan dialysis unit consists of a first stage Donnan dialysis unit for removing ammonium and a second stage Donnan dialysis unit for recovering hardness.

13. The method for the production of drinking water according to claim 1, further comprising:
extracting minerals from the feed water stream by using a combination of the Donnan dialysis unit and the membrane unit; and
using the minerals.
